(19) United States
(12) Patent Application Publication
(10) Pub. No.: US 2006/0231199 A1
(43) Pub. Date: Oct. 19, 2006

(54) Method for mounting mark on a composite material and the product made by the method

(76) Inventors: Ching-Lung Weng, Taichung City (TW); Tsan-Sheng Chen, Taichung City (TW); Chun-Hao Yang, Taichung City (TW); Ding-Guei Huang, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/377,185

(22) Filed: Mar. 17, 2006

(30) Foreign Application Priority Data
Apr. 13, 2005 (TW) 094111760

(51) Int. Cl. B32B 9/04; B32B 37/00; B32B 37/10; B29C 47/00; B29C 65/00

(52) U.S. Cl. 156/285; 156/307.1; 156/307.7; 156/245; 156/286; 428/411.1

(57) ABSTRACT

A method for mounting a piece on an object includes a step of providing an un-cured composite material; a step of providing at least one piece on a surface of the composite material, and a step of co-curing the piece and the composite material to secure the piece to the composite material. The piece can be a label, a mark or a pattern which can be combined with the object by way of co-curing formation.

### FIELD OF THE INVENTION

The present invention relates to a method for mounting a mark on a composite material wherein the mark is co-cured with the composite material, and the product made by the method.

### BACKGROUND OF THE INVENTION

A conventional way to attached a mark on a surface of an object made by plastic or composite material is to spread an ink material, to thermal transfer a mark or to stamp a pattern on the surface of the product. The mark or pattern can be spread or screen printed on the carbon-fiber surface. However, spreading, thermal transferring or screen printing cannot be used to mount a mark made by different material from the object on which the mark is to be mounted. If the marks are made by plastic or metal, the marks can only be attached to the objects by spreading a layer of adhesive resin and then the mark is adhered on the objects. It is noted that the composite material of the objects are cured when the marks are to be adhered thereon so that the marks protrude a thickness on the surface of the objects and tend to be scraped or peeled by friction.

Besides, the resin that is squeezed out from the periphery of the marks has to be removed from the surface of the objects, and this takes a lot of time and affects the appearance of the objects. The air bubbles in the resin reduce the connection of the marks and the surfaces of the objects. The surfaces of the objects and the marks are treated by detergent to remove grease thereon before adhering the marks on the surfaces of the objects.

The present invention intends to provide a method which allows the marks and the composite material to be cured simultaneously so as to be securely adhere the marks on the objects and the marks are in flush with the surfaces of the objects.

### SUMMARY OF THE INVENTION

The present invention relates to a method for mounting a piece on an object, wherein the method comprises the following steps:

step 1: providing an un-cured composite material;

step 2: providing at least one piece on a surface of the composite material, and

step 3: co-curing the piece and the composite material to secure the piece to the composite material.

The composite material is chosen from one of a high polymer based composite material, a metal-based composite material or a ceramic-sectioned including in ceramic and polymer composite material.

The un-cured composite material is chosen from one of a prepreg, a bulk molding compound (BMC), a sheet molding compound (SMC) or a wet lay-up.

The piece is chosen from one of a label, a mark, a pattern sheet or a character sheet.

The piece is chosen from one of a metal piece, a plastic piece, a high polymer foam piece, a metal foam piece, a ceramic material piece or a composite material piece.

The piece is chosen from one of a film, a thin sheet or a thin plate.

The piece includes a surface treatment layer.

The method for co-curing the piece and the composite material is one of the following methods which are press molding, vacuum forming, blow molding, thermal expansion molding, sandwich structural forming or filament winding.

The range of temperature for the step of co-curing is between room temperature to 1600 degrees Celsius.

The pressure for the step of co-curing is up to 100 atmospheres.

Another object of the present invention is to provide product with a piece mounted on an object by way of co-curing.

The piece and the composite material are co-cured to have a flat surface and a curve surface.

The composite material is chosen from one of a high polymer based composite material, a metal-based composite material or a ceramic-sectioned including in ceramic and polymer composite material.

The piece is chosen from one of a label, a tag, a pattern sheet or a character sheet.

The piece is chosen from one of a metal piece, a plastic piece, a high polymer foam piece, a metal foam piece, a ceramic material piece or a composite material piece.

The piece is chosen from one of a film, a thin sheet or a thin plate.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a flow chart of the method of the present invention;

FIG. 2 shows an exploded view to show the piece, the composite material and the forming mold of the method of the present invention;

FIG. 3 shows the vacuum packing material coated to the composite material, the piece and the base resin;

FIG. 4 shows a cross sectional view of the produce made by the method of the present invention;

FIG. 5 shows the steps of the step of co-curing;

FIG. 6 shows multiple embodiments of the products, and

FIG. 7 shows a cross sectional view of another embodiment of the product made by the method.

### DETAILED DESCRIPTION OF THE PREFERRED EMBODIMENT

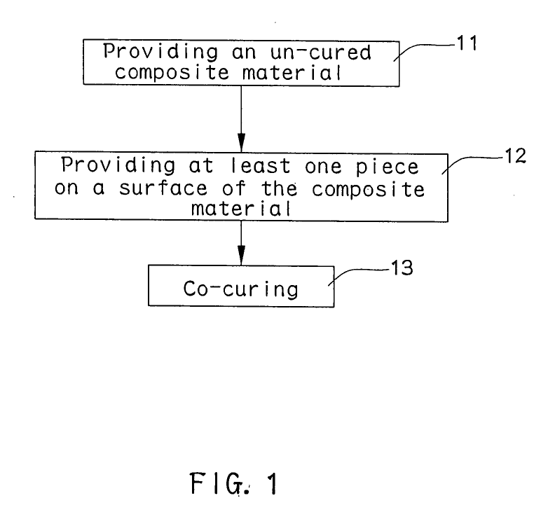

Referring to FIG. 1, the method for mounting a piece on an object of the present invention comprises a step one 11: providing an un-cured composite material 20, wherein the composite material 20 is chosen from one of a high polymer based composite material, a metal-based composite material or a ceramic-sectioned including in ceramic and polymer composite material. The un-cured composite material is chosen from one of a pre-preg, a bulk molding compound (BMC), a sheet molding compound (SMC) or a wet lay-up, the composite material 20 includes specific weight of 30% to 60% of base resin 21 which is thermal-setting plastic or thermal-plastic resin including epoxy resin.

A step two 12: providing at least one piece 30 on a surface of the composite material 20. The piece 30 can be put on a surface of a forming mold 40 and is positioned on the surface of the composite material 20 after-the composite material 20 is filled into the forming mold 40. The piece 30 is chosen from one of a label, a mark, a pattern sheet or a character sheet. The material of the piece 30 can be chosen from one of a metal piece, a plastic piece, a high polymer foam piece, a metal foam piece, a ceramic material piece or a composite material piece. The piece 30 can be one of a film, a thin sheet or a thin plate. The piece 30 includes a surface treatment layer such as a plastic layer.

A step three 13: co-curing the piece 30 and the composite material 20 to secure the piece 30 to the composite material 20. The method for co-curing the piece 30 and the composite material 20 is one of the following methods which are press molding, vacuum forming, blow molding, thermal expansion molding, sandwich structural forming or filament winding. A range of temperature for the step of co-curing 13 is between room temperature to 1600 degrees Celsius, and the pressure for the step of co-curing is up to 100 atmospheres.

Taken the method of vacuum forming as an example, it includes the following steps:

step one 11: providing an un-cured composite material 20;

step two 12: providing at least one piece 30 on a surface of the composite material 20, and

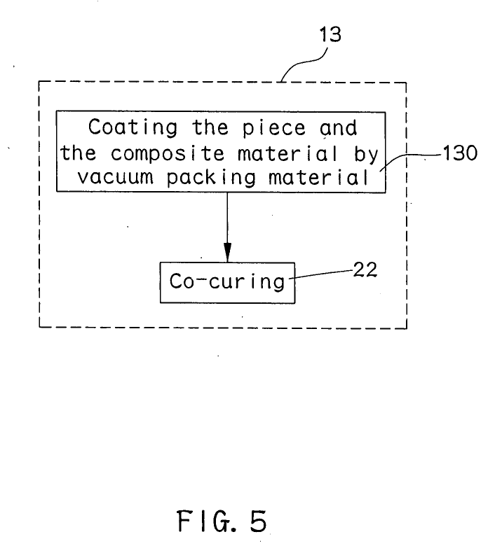

step three 13: co-curing the piece 30 and the composite material 20 to secure the piece 30 to the composite material 20 by way of vacuum forming as shown in FIG. 5, the vacuum forming includes the following steps:

a step 130 of put in the piece 30 and the composite material 20 by vacuum packing material: using a vacuum machine to vacuum the package which includes the packing material 22 coated onto a mold 40, the piece 30 and the composite material 20, and

a step 131 of co-curing: sending the mold and the composite material 20 into an oven or an autoclave to proceed a step of curing/consolidation according to requirements of temperature-pressure-time of the composite material 20 to form a cured semi product, the vacuum packing material 22 being removed from the semi product and the piece 30 is securely combined with the composite material.

The piece 30 can be easily and securely combined with the object made by composite material and the method is less expensive compared with conventional methods and the piece 30 is in flush with the surface of the object.

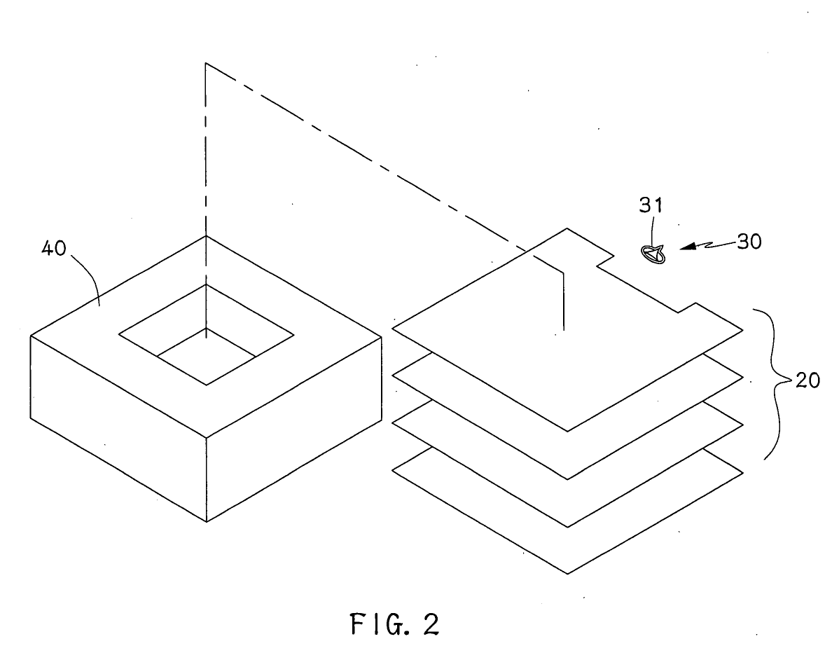

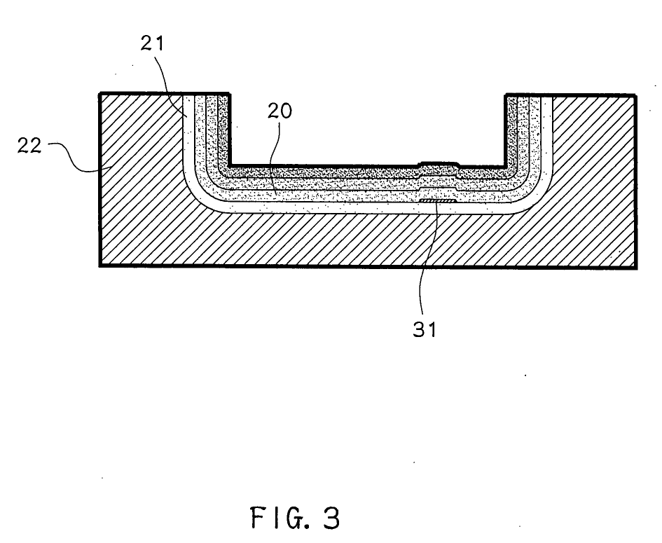

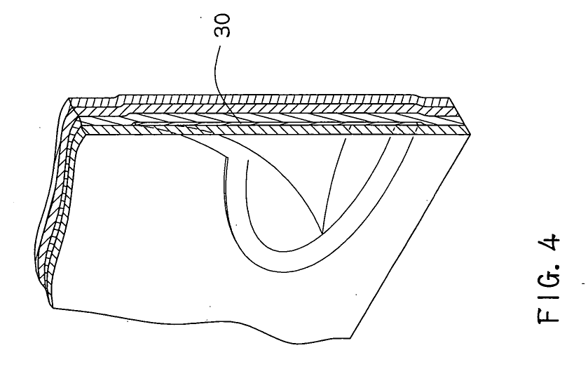

As shown in FIGS. 2, 3 and 4, a mark 31 is to be connected to a composite material 20 of carbon-fiber fabric/epoxy resin. The mark 31 is a aluminum thin sheet with a thickness of 0.01 to 0.3 mm and has no back adhesive. The mark 31 is co-cured with the composite material 20 of carbon-fiber fabric/epoxy resin under heat and pressure to from a product “A”.

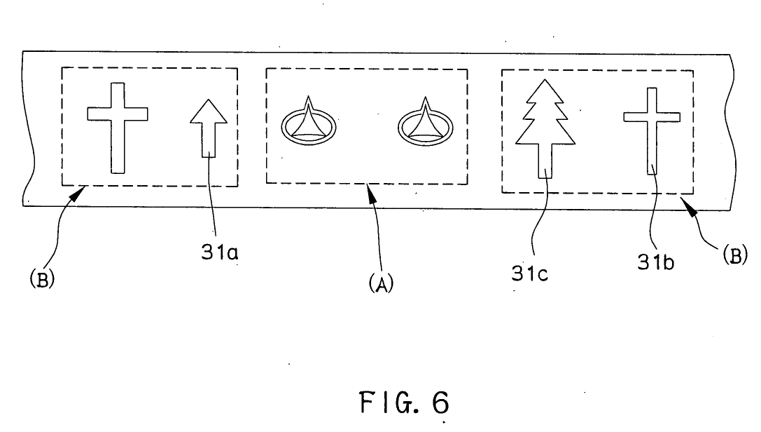

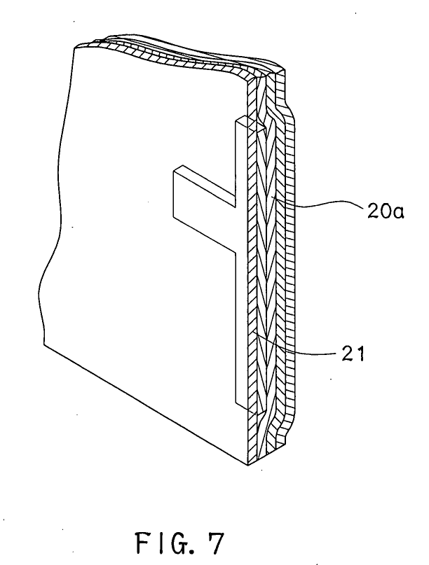

As shown in FIG. 6 which shows another embodiment of the product wherein the piece 30 is a pattern plate 31a made by Magnesium, Iron or Nickel alloy, a cross-shaped pattern plate 31b and a decoration pattern 31c. The mark 31c is a Magnesium alloy plate without back adhesive and the thickness is between 0.2-0.3 mm. As shown in FIG. 7, the mark 31c is put on a surface of the KEVLAR fabric/epoxy resin 20a. By using the co-curing method, the mark is secured to the composite material to form a product “B”.

Because the resin can be deformed so that the mark can be positioned in flush with the surface of the object after being co-cured, and the surface can be a flat or curve surface. The mark can be avoided from being scrubbed or peeled by foreign objects. There will be not necessary to use adhesive because the resin can adhere the mark well so that the resin will not squeezed out from the periphery of the mark. By using the way of constrain and cooperated with the mold, no extra resin is squeezed out from the mark. By using vacuum forming, the air bubbles can be removed before co-curing so that the mark is well secured to the object. The marks can be made by different material such as metal, plastic or glass and the number of the pieces can be formed with the object according to practical needs.

While we have shown and described the embodiment in accordance with the present invention, it should be clear to those skilled in the art that further embodiments may be made without departing from the scope of the present invention.

What is claimed is:

1. A method for mounting a piece on an object, comprising:
step 1: providing an un-cured composite material;
step 2: providing at least one piece on a surface of the composite material, and
step 3: co-curing the piece and the composite material to secure the piece to the composite material.

2. The method as claimed in claim 1, wherein the composite material is chosen from one of a high polymer based composite material, a metal-based composite material or a ceramic-sectioned including in ceramic and polymer composite material.

3. The method as claimed in claim 1, wherein the un-cured composite material is chosen from one of a prepreg, a bulk molding compound (BMC), a sheet molding compound (SMC) or a wet lay-up, the composite material includes specific weight of 30% to 60% of base resin which is thermal-setting plastic or thermal-plastic resin including epoxy resin.

4. The method as claimed in claim 1, wherein the piece is chosen from one of a label, a mark, a pattern sheet or a character sheet.

5. The method as claimed in claim 1, wherein the piece is chosen from one of a metal piece, a plastic piece, a high polymer foam piece, a metal foam piece, a ceramic material piece or a composite material piece.

6. The method as claimed in claim 1, wherein the piece is chosen from one of a film, a thin sheet or a thin plate.

7. The method as claimed in claim 1, wherein the piece includes a surface treatment layer.

8. The method as claimed in claim 1, wherein a method for co-curing the piece and the composite material is one of the following methods which are press molding, vacuum forming, blow molding, thermal expansion molding, sandwich structural forming or filament winding.

9. A method for mounting a piece on an object, comprising:
step 1: providing an un-cured composite material;
step 2: providing at least one piece on a surface of the composite material, and
step 3: co-curing the piece and the composite material to secure the piece to the composite material by way of vacuum forming which includes the following steps:
put in the piece and the composite material by vacuum packing material: using a vacuum machine to vacuum a package which includes the packing material coated onto a mold, the piece and the composite material, and
co-curing: sending the mold and the composite material into an oven or an autoclave to proceed a step of curing/consolidation according to requirements of temperature-pressure-time of the composite material to form a cured semi product, the vacuum packing material being removed from the semi product and the piece securely combined with the composite material.

10. The method as claimed in claim 9, wherein a range of temperature for the step of co-curing is between room temperature to 1600 degrees Celsius.

11. The method as claimed in claim 9, wherein the pressure for the step of co-curing is up to 100 atmospheres.

12. A product comprising a composite material and at least one piece which is co-cured with the composite material and secured to a surface of the composite material.

13. The product as claimed in claim 12, wherein the piece and the composite material are co-cured to have a flat surface and a curve surface.

14. The product as claimed in claim 12, wherein the composite material is chosen from one of a high polymer based composite material, a metal-based composite material or a ceramic-sectioned including in ceramic and polymer composite material.

15. The method as claimed in claim 12, wherein the piece is chosen from one of a label, a mark, a pattern sheet or a character sheet.

16. The method as claimed in claim 12, wherein the piece is chosen from one of a metal piece, a plastic piece, a high polymer foam piece, a metal foam piece, a ceramic material piece or a composite material piece.

17. The method as claimed in claim 12, wherein the piece is chosen from one of a film, a thin sheet or a thin plate.
